(19) United States
(12) Patent Application Publication
(10) Pub. No.: US 2015/0342403 A1
(43) Pub. Date: Dec. 3, 2015

(54) SELF-STANDING CONTAINER FOR PRE-SOAKING GRILLING PLANK

(71) Applicant: Eric J. Wangler, Rochester, NY (US)

(72) Inventor: Eric J. Wangler, Rochester, NY (US)

(21) Appl. No.: 14/700,980

(22) Filed: Apr. 30, 2015

Related U.S. Application Data
(60) Provisional application No. 62/004,449, filed on May 29, 2014.

(51) Int. Cl. A47J 37/07; B05D 1/18; B65D 65/38; B65D 30/10; B65D 33/25; B65D 81/22

(52) U.S. Cl. CPC A47J 37/0786; B65D 33/2591; B65D 81/22; B65D 65/38; B65D 31/16; B05D 1/18

(57) ABSTRACT

A self-standing container for holding and pre-soaking a cooking plank in a soaking liquid includes flexible walls forming a bag-like container with a chamber to receive the plank and the liquid. The container includes a deployable standing structure to enable the container to be placed in an upright position to conserve counter space. The container with a plank and liquid may be packaged for retail sale and later reuse.

### CROSS REFERENCE TO RELATED APPLICATION

This application claims the benefit of U.S. Prov. App. Ser. No. 62/004,449, filed May 29, 2014, which is incorporated by reference herein.

### BACKGROUND OF THE INVENTION

The present invention is directed to cooking and, more particularly, to materials and equipment for use in plank cooking. Cooking food on hot wooden planks arose from the Pacific Northwest native art of plank-grilling, an ancient tradition of cooking fresh fish and game on various types of woods. Plank grilling fish and other foods on sections of soaked aromatic woods set over a grill is somewhat akin to barbecuing. As the food cooks, essentially basting itself in its own oils and juices, it absorbs fragrant wood smoke to achieve a layering of flavors. In addition to cooking foods on wooden planks over open fires or coals, planks can also be used for oven cooking.

In order to properly use a wooden plank to prepare and cook food, the plank must be thoroughly soaked in water or other liquid, such as juice, cider, or wine, for anywhere from about twenty minutes to six hours or longer. Typically, the plank is placed in a pan or bucket and weighed down to keep it submerged. Proper soaking is required to produce the optimal amount of smoke for food cooking and flavor without the risk of flaming.

A disadvantage of conventional approaches to soaking cooking planks is the space on a counter, table, or the like that must be occupied by the apparatus used for soaking such planks, particularly for a family or party sized gathering. In addition, sufficient time must figured into planning for the meal to allow the planks to adequately soak.

### SUMMARY OF THE INVENTION

The present invention is directed to a self-standing container for soaking a wooden plank and including flexible side walls joined at opposite side edges thereof to form a soaking chamber therein, an opening at upper ends of the side walls and communicating with the chamber, a closure mechanism engaged between the upper ends of the side walls to selectively seal the opening, and a standing mechanism sealing lower ends of the side walls, the standing mechanism being selectively deployable to enable positioning the container in an upstanding orientation.

An embodiment of the invention includes a container or packaging for holding and pre-soaking a cooking platform, such as a wooden grilling plank for supporting and flavoring a food during cooking, grilling, baking, or roasting. The container holds the platform or wooden plank and a quantity of soaking liquid such as water, broth, or juice. The container is made of a food-safe material that is also water-resistant. Suitable materials include plastic, paper and metal foil. The container is preferably sealable, such as by a locking zipper seal, to hold the plank and soaking liquid therein. In the present invention, the container includes a standing structure or mechanism, such as a pleat, gather, or gusset in the bottom wall thereof, which is openable to form a supportive base, so that the container can be set on end in an upstanding orientation to thereby take up less counter space. Prior to use, the wooden plank is soaked in the liquid in the container but may also be pre-soaked, such that the wooden plank remains wet when placed on a grill or the like and smolders during the cooking process without flaming, thereby smoking and flavoring the food.

In an embodiment of the invention, the container is a form of pouch or bag including a pair of flexible walls or panels, each with inner and an outer surfaces, which are joined at side edges and at or near lower ends of the container. The inner surfaces form an interior soaking chamber that is sized and shaped for receiving a wooden plank and a quantity of liquid therein. The container walls are open at a top end and include a closure or sealing structure or mechanism that is selectively opened and closed. The lower end of the container is sealed and includes a standing structure for positioning the container in an upstanding orientation. In an embodiment of the container, the standing structure is formed by one or more of the walls and includes a pleat, a gather, or a gusset sealingly joined to the walls. In another further embodiment, the standing structure is removably attachable to at least one of the walls.

Generally, the container is impervious to liquids and gases. In an embodiment, the walls may be formed of a flexible, liquid impermeable film which may include polymer, paper, and/or metal foil components which are safe for use around foods. In an exemplary embodiment, the material may be a polyester film or a laminate of a polyester film with a metal foil.

In a further embodiment, the closure is adjacent to the opening or includes the opening. Useful closures include, but are not limited to, zipper sealing structures, also referred to as self-locking separable seam type closures. Such zipper sealing structures are typically sliderless and formed by an elongated polymer bead on one surface which is sealingly received within a groove on an opposite surface. In some zipper structures, multiple beads are received in corresponding grooves. An example of such a type of sealing structure is shown in U.S. Pat. No. 2,558,367, which is incorporated herein by reference.

In another further embodiment, the container is combined with a wooden plank that is sized and shaped to be received through the opening and into the chamber.

In another embodiment, a method of soaking such a wooden plank includes the steps of providing a container including an interior, an exterior, an inner soaking chamber, an opening, a closure for the opening with opened and closed configurations and a standing structure; providing a wooden plank for cooking a food thereon; inserting the wooden plank through the passage and into the chamber; closing the container by placing the closure in the closed orientation; actuating the standing structure; and positioning the container in an upstanding orientation.

In a further embodiment, the step of inserting the wooden plank through the passage and into the chamber includes placing a quantity of a soaking liquid through the passage and into the chamber. In another further embodiment, the step of placing a quantity of a soaking liquid through the passage and into the chamber includes covering the wooden plank with the soaking liquid. In yet another further embodiment, the step of actuating the standing structure includes placing the containing structure in an orientation wherein the soaking liquid is substantially contained within the chamber.

Various objects and advantages of this invention will become apparent from the following description taken in relation to the accompanying drawings wherein are set forth, by way of illustration and example, certain embodiments of this invention.

The drawings constitute a part of this specification, include exemplary embodiments of the present invention, and illustrate various objects and features thereof.

### BRIEF DESCRIPTION OF THE DRAWINGS

FIG. 1 is a perspective view of pre-soaked wooden planks supporting food on a charcoal grill.

FIG. 2 is a perspective view of a filled and sealed container according to the present invention wherein the container is positioned in an upright orientation and contains a wooden plank (shown in phantom lines) and a quantity of soaking liquid.

FIG. 3 is a reduced front elevational view of the container and wooden plank (shown in phantom lines) of FIG. 2, wherein the plank is shown immersed in the soaking liquid.

FIG. 4 is a front elevational view of the container and wooden plank (shown in phantom lines) with a standing structure deployed.

FIG. 5 is a reduced side elevational view of the container and wooden plank (shown in phantom lines).

FIG. 6 is an enlarged perspective view of a lower end of the container and wooden plank.

FIG. 7 is a reduced perspective view of the container and wooden plank (shown in phantom lines), illustrating a step of adding the soaking liquid to the container.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings in more detail, the reference numeral 200 generally designates a self-standing container, according to the present invention, for holding and pre-soaking a grilling plank 100.

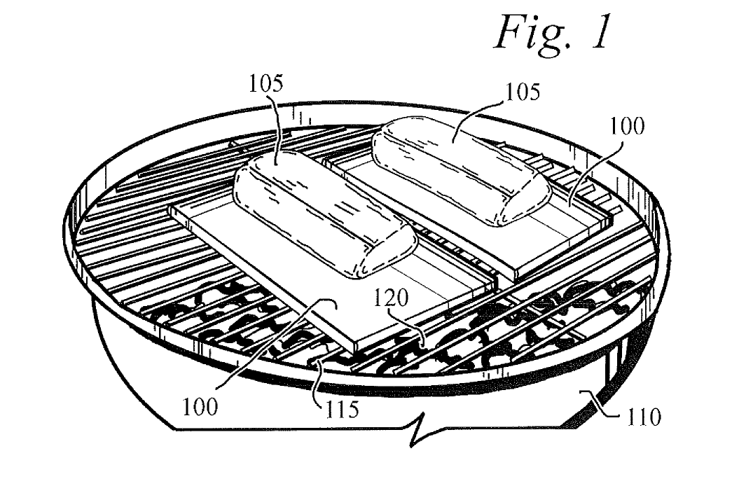

FIG. 1 illustrates the plank, platform, support or device 100 for supporting and flavoring a food during cooking. The soaking container or packaging structure 200 holds the wooden plank 100 within the interior thereof. As shown in FIG. 1, the wooden plank 100 is adapted to support an item food 105 during cooking, such as cooking over a grill 110. The illustrated grill 100 includes a grate 115 that supports the wooden plank 100 above or near a cooking heat source 120 such as, but not limited to, a charcoal fire or a gas fire. Alternatively, the wooden plank 100 is receivable onto a baking sheet or pan, and the cooking can be performed by baking with an oven (not shown), cooking over an open camp fire, or the like. Such cooking methods are commonly referred to as “planking” or grilling on a wooden plank. Often, foods are cooked on planks indirectly by heated air and smoke within a closed grill rather than by direct radiant heat.

In some circumstances, one or more wooden planks 100 may be packaged together for sale to an end user. In circumstances wherein a plurality of wooden planks 100 are sold in a package, each of the wooden planks 100 may be individually wrapped in a container 200; and then the plurality of individually wrapped planks 100 may be packaged, wrapped, bundled or bound together, such as to enable the user to use one individually wrapped wooden plank 100 at a time, so that the remaining individually wrapped wooden planks 100 are substantially prevented from drying out in the opened package.

Generally, the packaging structure or container 200 is water-resistant or waterproof and air-resistant. The terms water-resistant, waterproof, and water-tight are used herein in their ordinary senses to mean, without limitation, relatively unaffected by water, such as resisting the egress of water from unopened packaging such as, but not limited to, egress by evaporation during storage. Water-resistant and waterproof packaging a known in the art. The term air-resistant is used herein in its ordinary sense to mean, without limitation, relatively unaffected by air, such as by the ingress or egress of air from unopened packaging during storage. Air-resistant packaging is known in the art. In some embodiments, the packaging structure may be adapted to substantially prevent loss of liquid, so as to substantially prevent the wooden plank 100 from drying out.

The packaging structure is manufactured from a food-safe material including, but not limited to plastic, paper, metal foil, and combinations or laminations thereof. The term food-safe is used herein in its ordinary sense to mean, without limitation, suitable for contact with food as defined by described in 21 CFR 174 through 21 CFR 190. Food contact materials include, but are not limited, to certain plastics, rubber, paper, coatings, and metals. In many cases a combination of such materials may be used to fabricate a package structure. In some circumstances, the packaging structure may be a shrink-wrap.

The wooden plank 100 can be made using any type of wood, so long as the wood is a food-safe wood. However, wood plank grilling is usually performed using an aromatic type of wood or wood from a fruit tree. Accordingly, in some embodiments, the wooden plank 100 may include a wood selected from a group including oak wood, maple wood, pine wood, cedar wood, alder wood, hickory wood, mesquite wood, ash wood, cherry wood, apple wood, pear wood, and the like. The wooden plank 100 should not be made from woods that are not food-safe, such as wood derived from plants that are poisonous, toxic, or noxious to humans or wood that have been soaked or coated in poisonous, toxic, noxious, or unappetizing chemicals or substances.

In some circumstances, the wooden plank 100 may be treated to enhance flavor of the food during cooking. For example, the wooden plank 100 can be roasted, coated with one or more herbs, spices, and salt, or soaked in a flavoring liquid such as, but not limited to, flavored water, juice, wine, cider, and the like. Such flavoring techniques are known in the art.

Generally, the wooden plank 100 is sized and shaped, or otherwise adapted, to support a food during cooking. Common shapes include elongated, flat planks of wood. In some circumstances, the plank 100 may be oval or circular and may be generally short and flat, with a width and length sufficient to support a desired quantity of food. In other circumstances, such planks 100 may be short, flat rectangular or polygonal shapes. Typically, the plank 100 is shaped to hold a specific quantity of food. In some circumstances, the plank 100 may be sized to support multiple pieces of food. In some circumstances, the plank 100 may be sized and shaped to be received by a coordinating platter or pan after cooking, such as a serving platter. Such platters and pans may only be suitable for serving and not for use in an oven.

As noted above, the wooden plank 100 is soaked in a liquid. Generally, the wooden plank 100 is at least partially permeated or infused with the liquid. Accordingly, the liquid diffuses a distance into the wood. The distance that the liquid diffuses into the plank 100 depends upon several factors such as, but not limited to, the type of wood used, the type of liquid used, the length of the soaking time, the temperature, and the pressure. In various embodiments, the liquid diffuses into the wood a distance of about one-sixteen of an inch to about an inch or farther, wherein the distance is measured from the nearest surface of the wooden plank 100.

The wooden planks 100 can be soaked for various periods, durations, or lengths of time from about 20-minutes or less up to about 120-minutes or longer.

Generally, the wooden plank 100 is soaked such that it absorbs a quantity of the liquid that is sufficient to suppress at least some combustion thereof when the food is being cooked thereon. In some embodiments, the wooden plank 100 absorb a quantity of the liquid sufficient to enable the wooden plank 100 to smolder when placed over a fire. When the wooden plank 100 smolders, a fragrant smoke is produced. The fragrant smoke generally permeates and flavors the food being cooked on the wooden plank 100. Generally, the wooden plank 100 is adapted for cooking a food a gas grill, a charcoal grill 110, a wood fire, or in an oven, such as is known in the art.

A variety of liquids can be used to soak the wooden plank 100. Some liquids, such a water, only moisten the wooden plank 100 and do not substantially impart flavors thereto. Other liquids such as, but not limited to, juices, ciders, wines, and the like impart flavors to the wooden plank 100. Liquids that impart flavor to the wooden plank 100 can impart flavor to the food being cooked on the wooden plank 100, such as by the smoke created as the plank 100 burns, chars, smokes or smolders, such as is known in the art. In some circumstances, the liquid may include a flavoring, such as herbs, spices, salts, vinegar, juice, flavor extract, and the like. It is foreseen that a preservative may be included in the soaking liquid to preserve the soaked wooden plank 100 for a period of time, such as during storage until the plank 100 is used.

In another embodiment, a method of making a device for supporting and flavoring a food during cooking is provided. The method includes the steps of providing a wooden plank 100 and a quantity of liquid, such as is described above; submerging the wooden plank 100 in the quantity of liquid for a period of time, such as is described above, whereby at least some of the liquid penetrates the wooden plank 100; and packaging the wooden plank 100 in a packaging structure adapted to substantially prevent evaporation of the liquid that penetrated the wooden plank 100.

In some embodiments, the step of submerging the wooden plank 100 in the quantity of liquid may include soaking the wooden plank 100 in the quantity of liquid.

In some embodiments, the step of providing a wooden plank 100 may include providing a wooden plank 100 selected from a group including oak wood, maple wood, pine wood, cedar wood, alder wood, hickory wood, mesquite wood, ash wood, cherry wood, apple wood, pear wood, and the like.

In some embodiments, the step of providing a quantity of liquid includes providing a quantity of water. For example, in some embodiments, providing a quantity of water includes providing a flavoring such as, but not limited to, a flavoring described above.

In some embodiments, packaging the wooden plank 100 includes providing a self-standing, flexible packaging structure 200, such as a resealable bag or pouch.

In another embodiment a method of making a pre-soaked wooden plank for supporting and flavoring a food during cooking may be provided, including saturating a plurality of pre-cut wooden planks 100, such as the planks 100 described above.

In some circumstances, the step of saturating the plurality of pre-cut wooden planks 100 may include the use of a static batch vat soaking, a large batch steam pressure chamber treatment, or a serpentine conveyance through a tank of liquid, such as is known in the art.

In some embodiments, the planks 100 may be placed in an oxygen barrier polymer bag or polybag, such as is known in the art. Then the plank-filled bags are placed in a vacuum chamber, followed by removing the excess air from the bags, and then heat sealing the bags.

In some embodiments, the soaked planks 100 may be placed onto a conveyor with two rolls of barrier film, wherein one film is above and the other below the planks 100, then transporting the planks 100 into an automated scaling device, such as is known in the art. The bag is sealed on three sides, a vacuum is drawn, and the fourth side is sealed.

In some further embodiments, the ambient air may be purged from the bag with a gas prior to vacuuming and the final seal of the bag, whereby the plank 100 is preserved for an extended time by minimizing bacterial growth therein, such as is known in the art.

In some embodiments, the method may automated. In other embodiments, some or all steps of the method may be performed by hand.

In a further embodiment, each plank 100 may be individually packaged, and several packages of planks 100 may be enclosed in a retail package appropriate for sale to the consumer or end user.

In a further embodiment, natural or artificial flavor may be added to the liquid for soaking the planks 100.

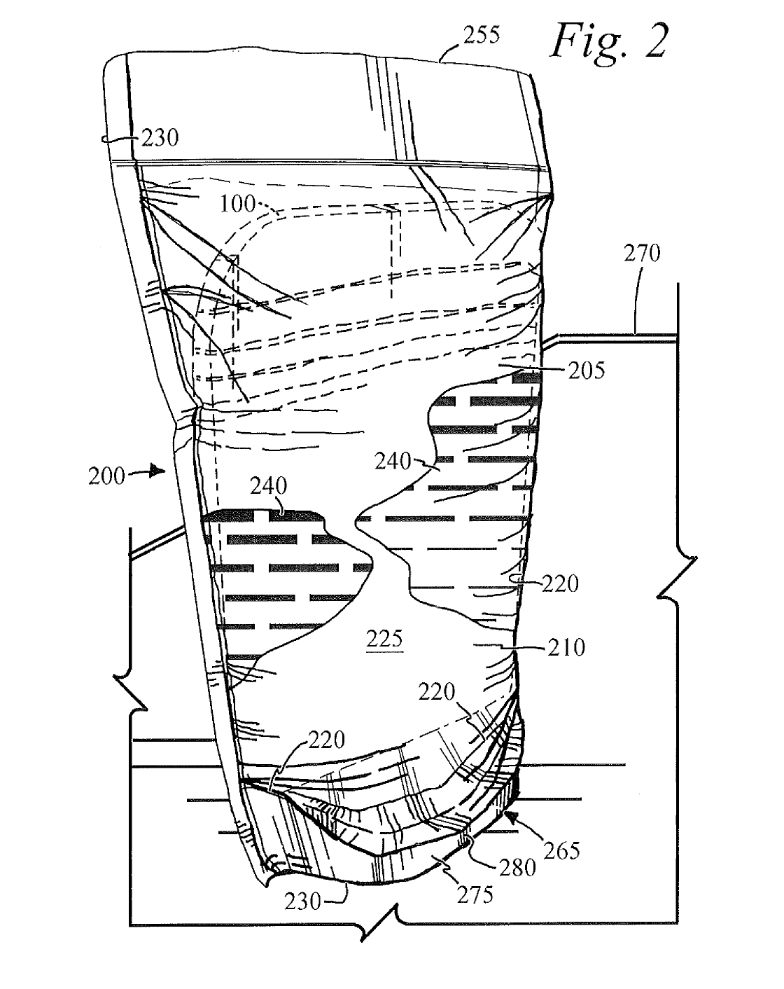

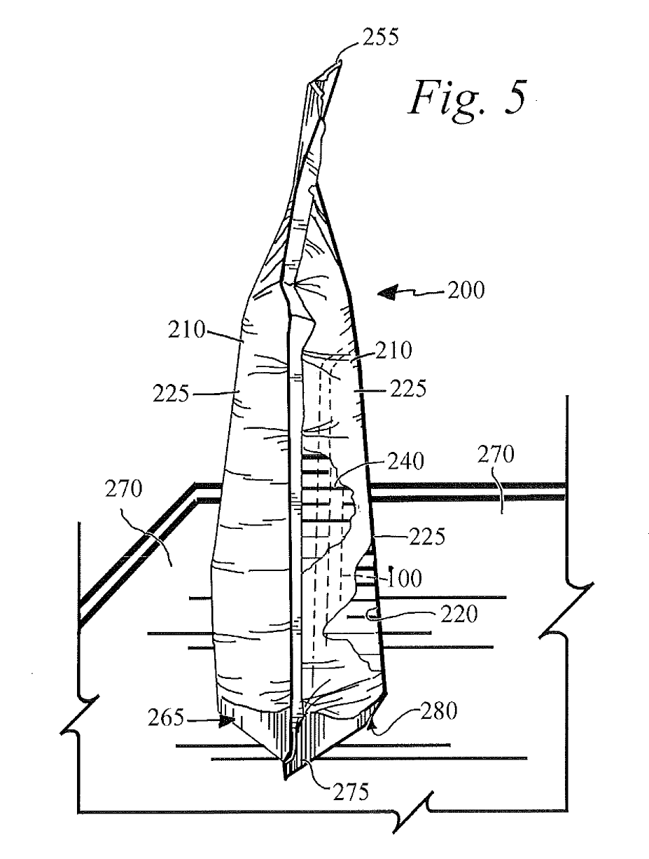

FIGS. 2-7 illustrate a bag or container 200 for containing and soaking a wooden plank 100, such as is described above with respect to FIG. 1. The container 200 includes a plurality of walls 205 such as, but not limited to, front and back walls 210 and a bottom wall 215. The walls 205 may be formed of a flexible polymer material that is food-safe and substantially waterproof or watertight, to prevent fluid leaks, such as is known in the art. In some embodiments, the polymer material may also be substantially air-proof, so as to substantially prevent air from passing through the walls 205. Such materials are commonly used in the food packaging art. In an exemplary embodiment of the container 200, the walls 210 and 215 are formed of a polyester film and may include paper, fabric, and/or foil materials laminated therewith.

Each of the walls 205 includes an inner surface 220 and an outer surface 225. The walls 205 are joined at their edges 230 or ends so as to form an interior soaking chamber 235. For example, the inner surfaces 220 may be joined or laminated at the edges 230, such that an un-laminated space is formed as the chamber 235. The edges 230 may be joined by thermal or adhesive means or by other methods known in the art. The chamber 235 is sized and shaped to receive at least one of the wooden planks 100. In some embodiments, the chamber 235 may be sized and shaped to contain or hold a quantity of a soaking liquid 240 therein. For example, the liquid 240 can be poured into the chamber 235, so that the plank 100 can be evenly soaked in the liquid, such as is described above.

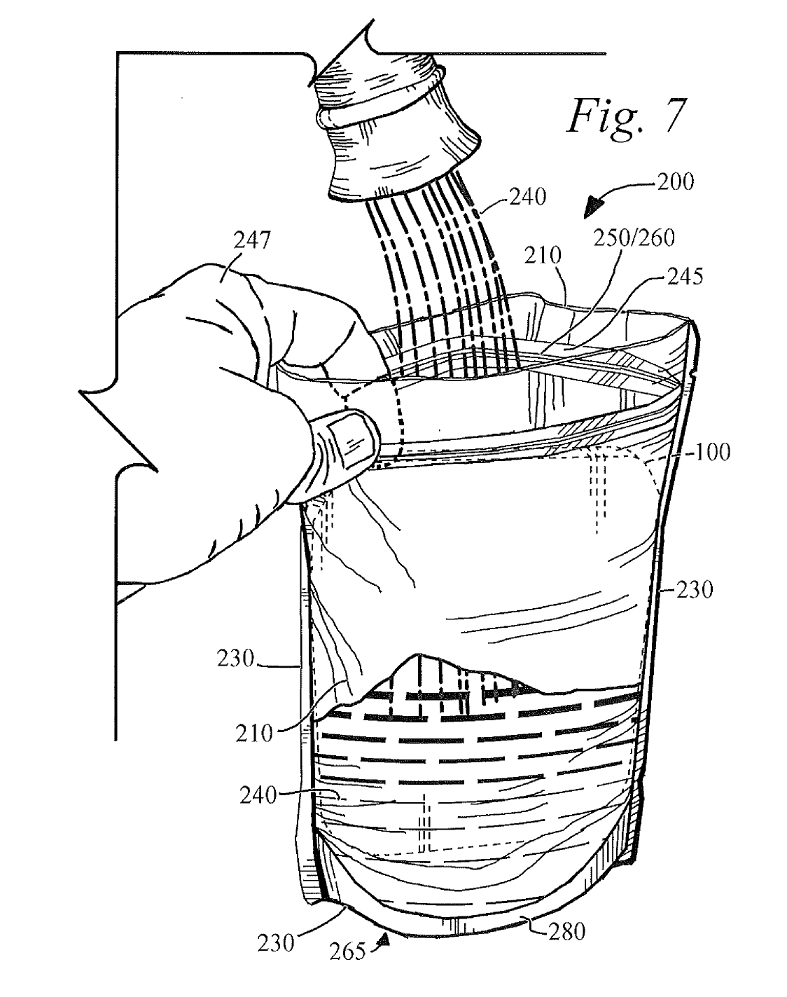

As shown in FIG. 7, the container 200 includes an opening 245 communicates with the chamber 235. The opening 245 is sized and shaped such that a plank 100 can pass therethrough and be received into the chamber 235. The opening 245 may be located at an end 250 such as at the top or upper end 255 of the container 200. The opening 245 is also sized such that a quantity of liquid 240, such as described above, can be introduced, poured, or placed into the chamber 235, such as is shown in FIG. 7. Flavorings (not shown) may also be placed into the chamber 235 through the opening 245.

The container 200 includes a closure or sealing structure or mechanism 250 at, or adjacent to, the container opening 245. The closure 250 is releasably engageable, so that the opening 245 can be selectively sealed or unsealed by the user 247. Closing the opening 245 prevents liquid 240 from spilling or exiting from the chamber 235. In preferred embodiments, the closing structure or closure 250 is water-tight and seals the plank 100 and the liquid 240 within the chamber 235, such that the plank and the liquid cannot exit from the chamber 235. Accordingly, the closure 250 prevents spilling or evaporation of the liquid 240 through the opening 245.

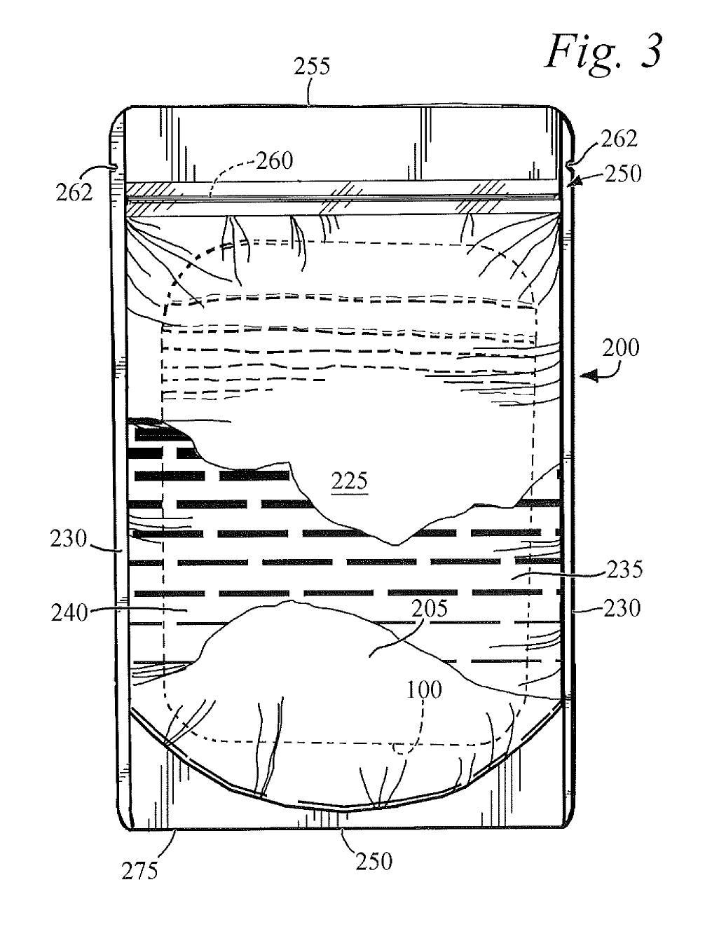

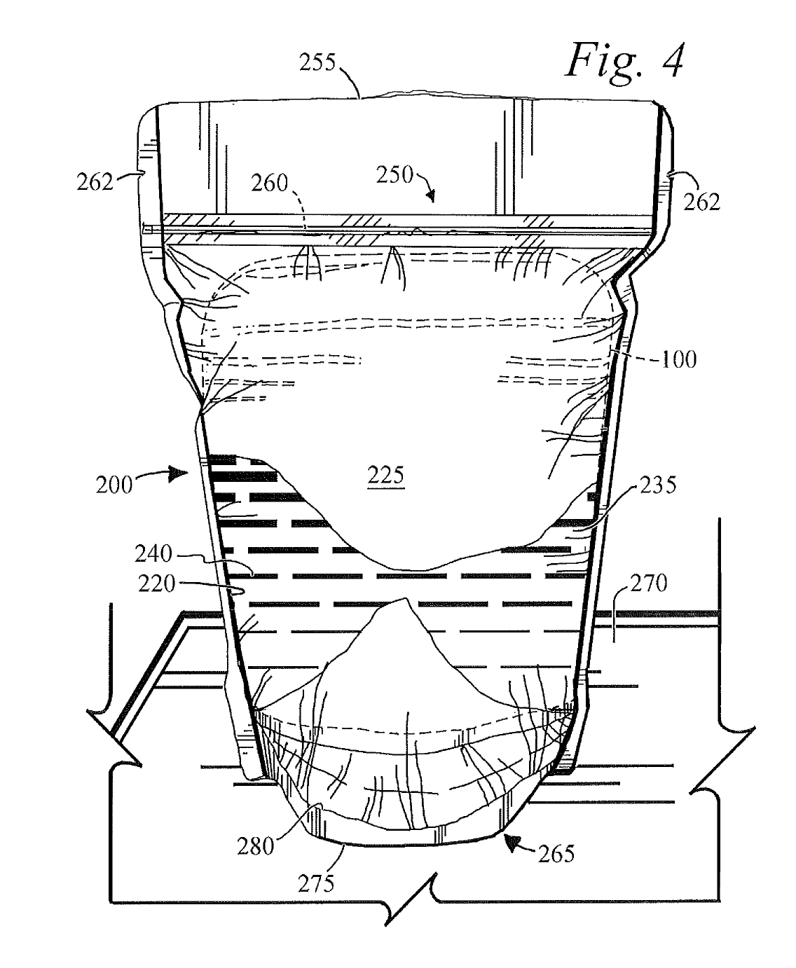

The closure 250 may be any appropriate sealing structure known in the art. Exemplary closures 250 may include, but are not limited to, a sliderless zipper seal 260, a clip, an adhesive strip or seal, a snap, and combinations thereof. Some closures 250 may be associated with or located on the wall inner surfaces 220 such as at, adjacent to, or within the opening 245. Other closures 250 may be associated with or located on the wall outer surfaces 225 such as at, adjacent to, or outside of the opening 245. It is foreseen that the upper ends of the walls 210 may be sealed above the zipper 260, such as for tamper protection. Outer edges 230 of the upper ends may be provided with notches 262 (FIGS. 3 and 4) along with a weakened line connecting the notches (not shown) to facilitate tearing the joined upper ends of the walls 210 away to provide access to the resealable zipper 260.

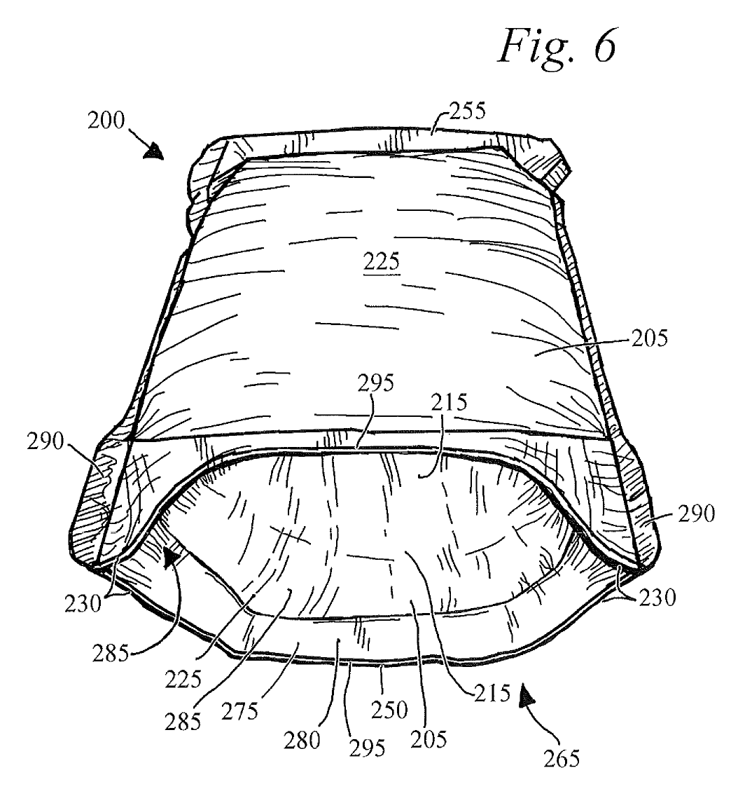

The illustrated container 200 includes a standing structure or mechanism 265 forming a base for positioning the container 200 in a stable, upstanding orientation, such as on a flat surface 270 which may be a counter top, a table top, a shelf, or the like, such as is shown in FIGS. 2, 4 and 5. Generally, the standing structure 265 is located at a bottom or lower end 275 of the container 200. As shown in FIG. 6, in some embodiments, the standing structure 265 may be formed of at or include least one of the walls 205.

In some embodiments, the standing structure 265 is formed of the lower ends 275 of the front and back walls 210 and the bottom wall 215 by bonding or attaching the bottom wall 215 to the inner surfaces 220 to form a spreadable and collapsible standing structure 280. As shown in FIG. 6, the walls 210 are joined at or adjacent to their edges by the bottom wall 215 which functions as a gusset to form an upwardly and inwardly folded pleat 285 which functions as the structure 280. Ends 290 (FIG. 6) of the gusset 215 may be joined for greater stability of the standing structure 280. The joined areas of the walls 210 and the gusset 215 are stiff enough to enable central regions 295 thereof to be spread to form a resilient structure sized and shaped to form the standing structure 280 that holds the container 200 in an upright orientation. Such an upright orientation prevents undesired spilling of liquid 240 from the chamber 235. Additionally, the upstanding orientation of the container occupies less surface on the counter top 270 than the container 200 in a flat lying orientation. Thus, a plurality of containers 200 can be positioned on the counter top 270 in the space occupied by a single container 200 lying flat. It is foreseen, however, that the user can position the container 200 in a lying down orientation, rather than in the upstanding orientation.

In other embodiments, the standing structure 265 may be removably attachable to at least one of the walls 205, such as at or adjacent to the bottom 275 of the container 200. Numerous removably attachable standing structures 265 are foreseen.

In another embodiment, a method of soaking a wooden plank 100 for cooking is provided. The method includes providing a containing structure 200 and a wooden plank 100 for cooking a food thereon, such as are described above. The wooden plank 100 is inserted through the opening 245 and into the chamber 235. A quantity of soaking liquid 240 may be poured into the chamber 235. For example, as shown in FIG. 7, the user 247 can hold the container 200 by the upper end 255, such as by the upper edges 230, so as to hold the opening 245 in an open position, orientation or configuration, and such that the liquid 240 can be poured into the chamber 235. The closure 250 is then sealed, for example, by closing the zipper seal 260. Then, the standing structure 265 is actuated, or opened, such that the container 200 can be placed on the counter top 270 in an upright or standing position or orientation (see FIGS. 2, 4-5 and 7). When the standing structure 265 is actuated and the container 200 is in an upright orientation, the liquid 240 is substantially contained within the chamber 235. It is foreseen that when in the upright orientation, the sealing structure 250 may not be closed, such that the opening 245 remains open.

In some embodiments, the plank 100 may be wrapped in the container 200 together with a soaking liquid 240. In such circumstances, the user may merely open the container 200, remove the pre-soaked plank 100 from the container 200 and proceed directly to cooking the food. In other embodiments, the plank 100 is wrapped in the container 200 without a liquid 240, such that the plank is sold in a dry state. The user opens the container 200 and adds the soaking liquid 240 to the chamber 235, such that the plank 100 can be soaked in the liquid 240.

In some embodiments, the container 200 may be washed out, such as after use, and then collapsed, such as by collapsing the standing structure 280, for storage and later reuse. When collapsed and empty, the container 200 is flat and easily stored.

It is to be understood that while certain forms of the present invention have been illustrated and described herein, it is not to be limited to the specific forms or arrangement of parts described and shown.

What is claimed and desired to be secured by Letters Patent is as follows:

1. A self-standing container for soaking a cooking plank and comprising:
(a) flexible walls joined at opposite side edges thereof to form a soaking chamber therein;
(b) an opening at upper ends of the walls which communicates with the chamber;
(c) a closure mechanism engaged between the upper ends of the walls to selectively seal the opening; and
(d) a standing mechanism sealing lower ends of the walls, the standing mechanism being selectively deployable to enable positioning the container in an upstanding orientation.

2. A container as set forth in claim 1 wherein:
(a) the side walls include a front wall and a back wall.

3. A container as set forth in claim 1 wherein:
(a) the closure mechanism is a sliderless zipper seal.

4. A container as set forth in claim 1 wherein the standing mechanism includes:
(a) a flexible gusset sealingly joined to inside surfaces of the walls at the lower ends to form a pleat which is selectively spread to form a base to support the container in the upstanding orientation.

5. A container as set forth in claim 4 wherein:
(a) side edges of the gusset are joined to increase stability of the standing mechanism.

6. A container as set forth in claim 1 wherein:
(a) the walls are formed of a polymer film.

7. A container as set forth in claim 1 in combination with:
(a) a wooden cooking plank positioned within the chamber; and
(b) a soaking liquid positioned within the chamber in contact with the plank to thereby soak the plank.

8. A self-standing bag for soaking a cooking plank and comprising:
(a) a pair of flexible walls joined at opposite side edges thereof to form a soaking chamber therein;
(b) an opening at upper ends of the walls which communicates with the chamber;
(c) a closure mechanism engaged between the upper ends of the walls to selectively seal the opening; and
(d) a standing mechanism sealing lower ends of the walls, the standing mechanism being selectively deployable to enable positioning the container in an upstanding orientation.

9. A bag as set forth in claim 8 wherein:
(a) the closure mechanism is a sliderless zipper seal.

10. A bag as set forth in claim 8 wherein the standing mechanism includes:
(a) a flexible gusset sealingly joined to inside surfaces of the walls at the lower ends to form a pleat which is selectively spread to form a base to support the container in the upstanding orientation.

11. A bag as set forth in claim 10 wherein:
(a) side edges of the gusset are joined to increase stability of the standing mechanism.

12. A bag as set forth in claim 8 wherein:
(a) the walls are formed of a polymer film.

13. A bag as set forth in claim 8 in combination with:
(a) a wooden cooking plank positioned within the chamber; and
(b) a soaking liquid positioned within the chamber in contact with the plank to thereby soak the plank.

14. A self-standing bag for soaking a cooking plank and comprising:
(a) a pair of flexible walls joined at opposite side edges thereof to form a soaking chamber therein;
(b) an opening at upper ends of the walls which communicates with the chamber;
(c) a sliderless zipper seal engaged between the upper ends of the walls to selectively seal the opening;
(d) a standing mechanism sealing lower ends of the walls, the standing mechanism being selectively deployable to enable positioning the container in an upstanding orientation;
(e) the standing mechanism being formed by a flexible gusset sealingly joined to inside surfaces of the walls at the lower ends to form a pleat which is selectively spread to form a base to support the container in the upstanding orientation.

15. A bag as set forth in claim 14 wherein:
(a) side edges of the gusset are joined to increase stability of the standing mechanism.

16. A bag as set forth in claim 14 wherein:
(a) the walls are formed of a polymer film.

17. A bag as set forth in claim 14 in combination with:
(a) a wooden cooking plank positioned within the chamber; and
(b) a soaking liquid positioned within the chamber in contact with the plank to thereby soak the plank.

18. A method of soaking a wooden cooking plank and comprising the steps of:
(a) providing a soaking container including:
(1) flexible walls joined at opposite side edges thereof to form a soaking chamber therein;
(2) an opening at upper ends of the walls which communicates with the chamber;
(3) a closure mechanism engaged between the upper ends of the walls to selectively seal the opening; and
(4) a standing mechanism sealing lower ends of the walls, the standing mechanism being selectively deployable to enable positioning the container in an upstanding orientation;
(b) inserting a wooden cooking plank into the chamber;
(c) pouring a soaking liquid into the chamber in contact with the plank;
(d) sealing the closure mechanism to retain the plank and liquid within the chamber;
(e) deploying the standing mechanism; and
(f) positioning the container with the standing mechanism deployed on a support surface to enable the liquid to soak into the plank.
